(19) United States
(12) Patent Application Publication
(10) Pub. No.: US 2009/0150348 A1
(43) Pub. Date: Jun. 11, 2009

(54) MANAGING DATA PRODUCED FROM DISCOVERIES CONDUCTED AGAINST SYSTEMS

(75) Inventor: Michael P. CLARKE, Ellenbrook (AU)

Correspondence Address: IBM CORP.;c/o SAWYER LAW GROUP LLP, P.O. BOX 51418, PALO ALTO, CA, 94303, US

(73) Assignee: INTERNATIONAL BUSINESS MACHINES CORPORATION, Armonk, NY (US)

(21) Appl. No.: 11/953,506

(22) Filed: Dec. 10, 2007

(51) Int. Cl. G06F 17/30

(52) U.S. Cl. 707/3; 707/E17.014

(57) ABSTRACT

Method, system, and computer program product for managing output reports produced from discoveries conducted against systems are provided. A discovery is conducted against a system to produce one or more output reports relating to configuration of the system. A signature is calculated for each output report. A determination is made as to whether each output report has a corresponding saved output report in a collection of saved output reports produced from one or more previously conducted discoveries against the system. For each output report having a corresponding saved output report, the signature for the output report is compared to a signature for the corresponding saved output report. In response to the signature for the output report being different from the signature for the corresponding saved output report, the corresponding saved output report in the collection of saved output reports is replaced with the output report.

### BACKGROUND

More and more businesses are utilizing discovery to manage their information technology (IT) infrastructure. Discovery allows a business to not only determine what assets (e.g., servers, networks, storages, applications, and so forth) are included in its IT infrastructure, but also to visualize the interconnections between various assets in the IT infrastructure. In order for discovery to be effective, it must be conducted frequently. As a result, a substantial amount of data will be produced from discoveries, which will need to be managed.

### SUMMARY

Method, system, and computer program product for managing output reports produced from discoveries conducted against systems are provided. In one implementation, a discovery is conducted against a system. The discovery produces one or more output reports relating to configuration of the system. A signature is calculated for each output report based on one or more lines of data contained in the output report. The one or more lines of data do not include any information with regards to timing of the discovery conducted against the system. A determination is made as to whether each output report has a corresponding saved output report in a collection of saved output reports produced from one or more previously conducted discoveries against the system. For each output report having a corresponding saved output report in the collection of saved output reports, the signature for the output report is compared to a signature for the corresponding saved output report to determine whether information in the output report differs from information in the corresponding saved output report. In response to the signature for the output report being different from the signature for the corresponding saved output report, the corresponding saved output report in the collection of saved output reports is replaced with the output report.

### DESCRIPTION OF DRAWINGS

FIG. 1 depicts a process for managing output reports produced from discoveries conducted against systems according to an implementation.

FIG. 2 illustrates a system for conducting discoveries against systems according to an implementation.

FIGS. 3A-3B show a process for managing output reports produced from discoveries conducted against systems according to an implementation.

FIG. 4 is a block diagram of a data processing system with which implementations of this disclosure can be implemented.

### DETAILED DESCRIPTION

This disclosure generally relates to managing data produced from discoveries conducted against systems. The following description is provided in the context of a patent application and its requirements. Accordingly, this disclosure is not intended to be limited to the implementations shown, but is to be accorded the widest scope consistent with the principles and features described herein.

Discovery can be utilized by businesses to identify information technology (IT) assets (e.g., servers, workstations, networks, applications, storages, processes, etc.), to determine interconnections between IT assets, to visualize dependencies among IT assets, to understand how IT assets are configured and being used, and so forth. This allows businesses to ensure that their IT infrastructures deliver measurable values, comply with regulations, are auditable, and so on.

To be effective, discovery must be conducted frequently in order to detect changes being made to an IT infrastructure. In addition, results of a discovery must be stored so that there can be a basis for comparison and analysis of later collected discovery results. Consequently, management of discovery data is crucial given the amount of discovery data that will be produced and stored.

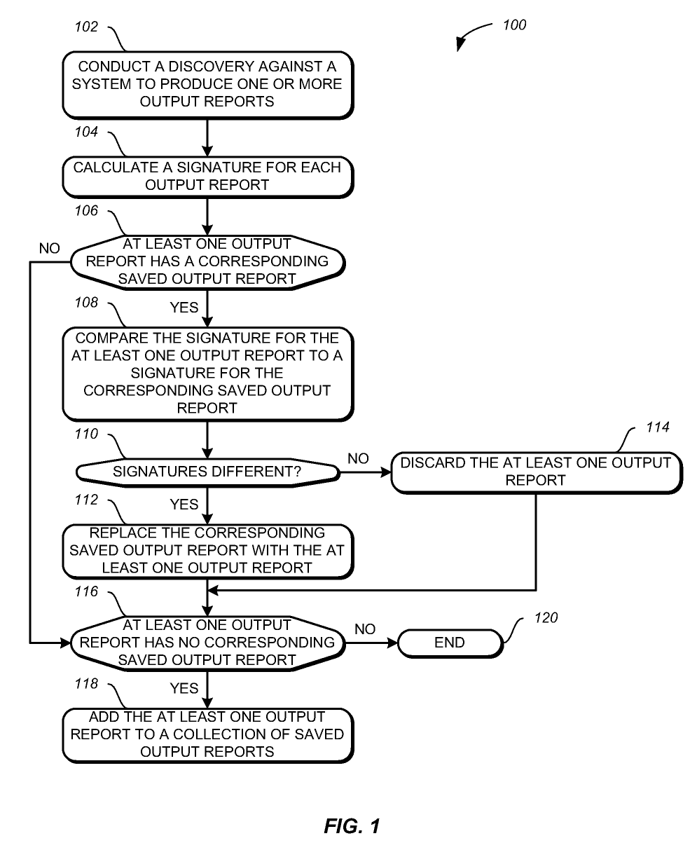

Illustrated in FIG. 1 is a process 100 for managing output reports produced from discoveries conducted against systems according to an implementation. At 102, a discovery is conducted against a system. The discovery produces one or more output reports relating to configuration of the system. Configuration of the system may be, for instance, types of assets in the system, number of assets in the system, relationships between assets in the system, or the like.

At 104, a signature is calculated for each output report based on one or more lines of data contained in the output report. The one or more lines of data do not include any information with regards to timing of the discovery conducted against the system (e.g., a timestamp reflecting when the discovery was conducted). In one implementation, the signature for each output report is calculated using an XOR checksum algorithm. Other types of checksum algorithms, such as MD5 (Message-Digest algorithm 5), may be used instead.

A determination is made at 106 as to whether at least one of the one or more output reports has a corresponding saved output report in a collection of saved output reports produced from one or more previously conducted discoveries against the system. For each output report having a corresponding saved output report, the signature for the output report is compared to a signature for the corresponding saved output report at 108. At 110, a determination is then made as to whether the signature for the output report is different from the signature for the corresponding saved output report.

If the signatures are different, then the corresponding saved output report in the collection of saved output reports is replaced with the output report at 112. If the signatures are the same, the output report is discarded at 114. A determination is made at 116 as to whether at least one of the one or more output reports has no corresponding saved output report in the collection of output reports. For each output report not having a corresponding saved output report, the output report is added to the collection of saved output reports at 118. Otherwise, process 100 ends at 120.

Adding an output report to the collection of saved output reports or replacing a corresponding saved output report in the collection of saved output reports with an output report may involve copying the output report to the collection of saved output reports. After the output report is copied to the collection of saved output reports, the output report can be discarded.

By only saving output reports that are either new or modified versions of saved output reports, time is not wasted on saving output reports that are identical to saved output reports already stored on disk. In addition, replacing saved output reports that have not changed results in timestamps being updated, which destroys valuable information concerning the original discovery and the stability of a system configuration.

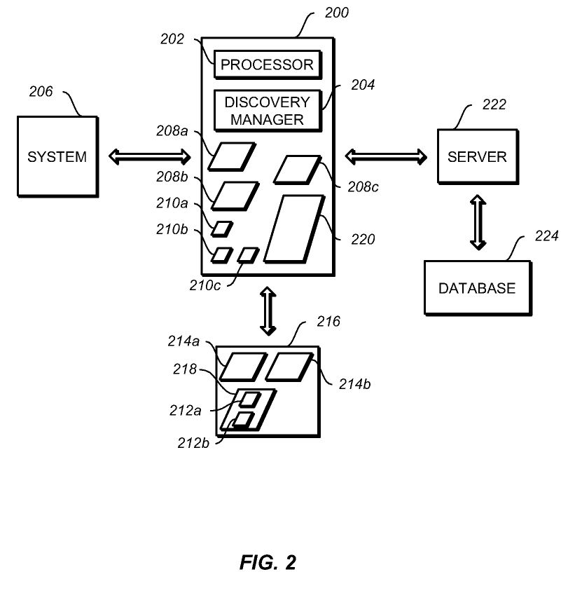

FIG. 2 depicts a discovery system 200 for conducting discoveries against systems according to an implementation. Discovery system 200 includes a processor 202 and a discovery manager 204 executing on processor 202. Other components (not depicted) may be included in discovery system 200. For example, discovery system 200 may include memory, additional processor(s), or the like.

In FIG. 2, discovery manager 204 conducts a discovery against a system 206 in communication with discovery system 200. Discovery system 200 and system 206 may be communicating via a network, such as a LAN (Local Area Network), a WAN (Wide Area Network), or the like. System 206 may include a plurality of assets (not depicted), such as servers, storages, networks, applications, and the like.

Output reports 208a-208c relating to configuration of system 206 are produced from the discovery conducted against system 206. Each output report 208 may include, for instance, information on a state of an asset in system 206 at the time of discovery.

A signature 210 is calculated for each output report 208 by discovery manager 204 based on one or more lines of data contained in each output report 208. Discovery manager 204 does not take into account any line of data that includes information on timing of the discovery conducted against system 206 when calculating each signature 210.

Discovery manager 204 compares the signatures 210 of output reports 208 to signatures 212 for saved output reports 214 in a collection of saved reports 216 to determine whether any of output reports 208 are an updated version of saved output reports 214. Signatures 212 are stored in a signature report 218 in collection 216. Although not depicted as such, collection 216 may be stored on a disk (not depicted), which could be a part of discovery system 200. In FIG. 2, discovery manager 204 has determined that output reports 208a and 208c are different from saved output reports 214. Thus, output reports 208a and 208c added to collection 216.

In the implementation, output report 208c is new. As a result, output report 208c can simply be copied to collection 216. Output report 208a, in contrast, is a modified version of saved output report 214a. Consequently, discovery manager 204 will replace saved output report 214a when copying output report 208a to collection 216.

Since output reports 208a and 208c are to be added to collection 216, discovery manager 204 will also update signature report 218 with signatures 210a and 210c for output reports 208a and 208c, respectively. Signature 210a will replace signature 212a in signature report 218 because output report 208a will replace saved output report 214a in collection 216. Signature 210c will be added to signature report 218 since output report 208c is new.

In addition to copying output reports 208a and 208c to collection 216, discovery manager 204 will also add output reports 208a and 208c to a list 220 of reports to be transmitted to a server 222. Server 222 may be in communication with discovery system 200 via a network (not depicted), such as a LAN, a WAN, or the like. An output report is transferred from discovery system 200 to server 222 for importation into a database 224 only if the output report is on list 220.

By limiting transmission of output reports to only those that are new or are updates of existing output reports, the overhead associated with transmitting output reports to servers and importing output reports to databases should be greatly reduced. In particular, less bandwidth will be needed because the amount of data that will need to be transmitted should be smaller. Additionally, the amount of time needed to transmit and import data should be less.

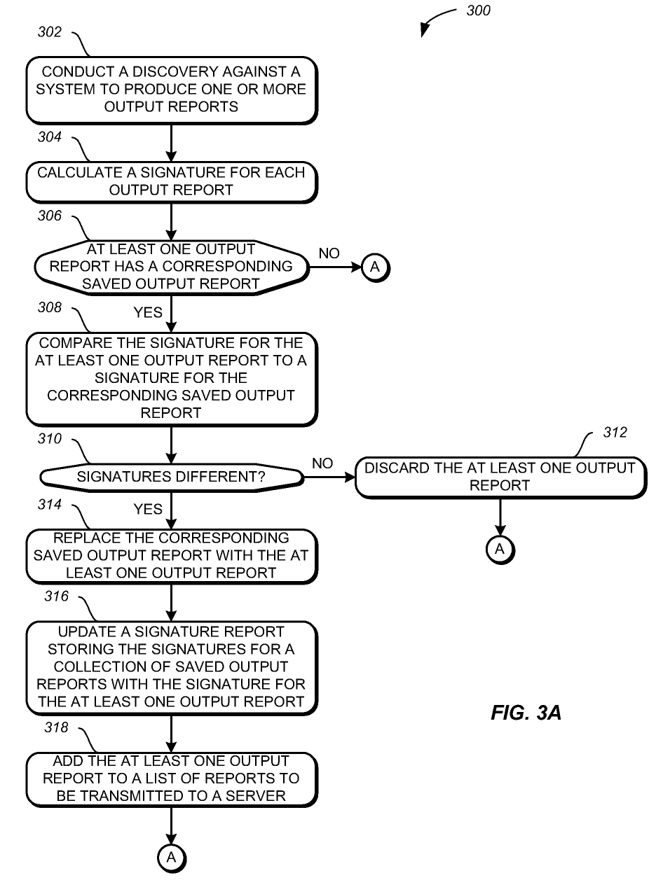

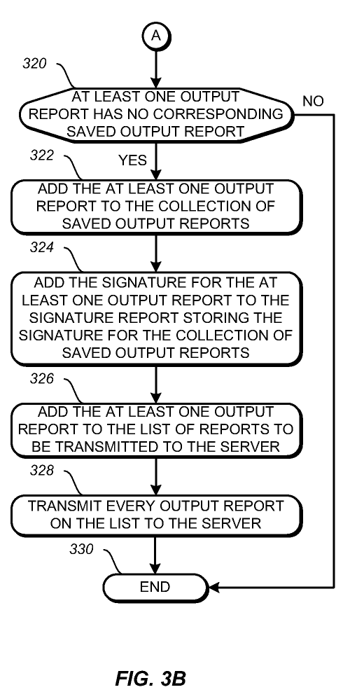

Shown in FIGS. 3A-3B is a process 300 for managing output reports produced from discoveries conducted against systems according to an implementation. At 302, a discovery is conducted against a system to produce one or more output reports relating to configuration of the system. A signature is calculated for each output report at 304 based on one or more lines of data contained in the output report. The one or more lines of data in which the signature is calculated based on do not include any line of data that are volatile and entirely an artifact of the discovery mechanism (e.g., always changes from one discovery session to another, such as timestamps and other meta data that do not contain information about the subject of the report).

A determination is made at 306 as to whether at least one output report has a corresponding saved output report in a collection of saved output reports from one or more previously conducted discoveries against the system. If not, process 300 proceeds to process block 320. If yes, the signature for the at least one output report is compared to a signature for the corresponding saved output report at 308 to determine whether information in the at least one output report differs from information in the corresponding saved output report.

At 310, a determination is made as to whether the signatures are the same. If the signatures are the same, then the at least one output report is discarded at 312. However, if the signatures are not the same, then the corresponding saved output report in the collection of saved output reports is replaced with the at least one output report at 314.

A signature report storing the signatures for the collection of saved output reports is updated with the signature for the at least one output report at 316 (e.g., the signature for the corresponding saved output report is replaced with the signature for the at least one output report). The at least one output report is also added to a list of output reports to be transmitted to a server at 318.

At 320, a determination is made as to whether at least one output report has no corresponding saved output report in the collection of saved output reports. If not, process 300 ends at 330. Otherwise, the at least one output report is added to the collection of saved output reports at 322, the signature for the at least one output report is added to the signature report storing the signatures for the collection of output reports at 324, and the at least one output report is added to the list of output reports to be transmitted to the server at 326. Every output report on the list is then transferred to the server at 328 for importation into a database.

This disclosure can take the form of an entirely hardware implementation, an entirely software implementation, or an implementation containing both hardware and software elements. In one implementation, this disclosure is implemented in software, which includes, but is not limited to, application software, firmware, resident software, microcode, etc.

Furthermore, this disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

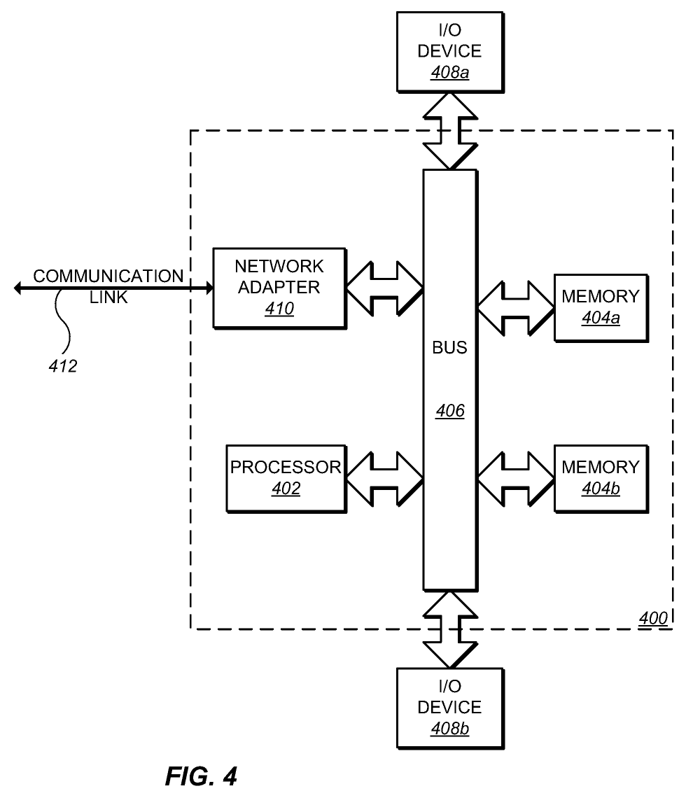

FIG. 4 depicts a data processing system 400 suitable for storing and/or executing program code. Data processing system 400 includes a processor 402 coupled to memory elements 404a-b through a system bus 406. In other implementations, data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to data processing system 400. I/O devices 408a-b may be coupled to data processing system 400 directly or indirectly through intervening I/O controllers (not shown).

In the implementation, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

While various implementations for managing data produced from discoveries conducted against systems have been described, the technical scope of this disclosure is not limited thereto. For example, this disclosure is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components.

In addition, this disclosure is applicable when used against reports that are frequently produced from a body of data that changes slowly compared to the frequency with which the reports are produced. That is to say, when most newly generated reports are the same as previously generated reports. Hence, various modifications or improvements can be added to the above implementations and those modifications or improvements fall within the technical scope of this disclosure.

1. A method for managing output reports produced from discoveries conducted against systems, the method comprising:
conducting a discovery against a system to produce one or more output reports relating to configuration of the system;
calculating a signature for each output report based on one or more lines of data contained in each output report, the one or more lines of data not including any information with regards to timing of the discovery conducted against the system;
determining whether each output report has a corresponding saved output report in a collection of saved output reports produced from one or more previously conducted discoveries against the system; and
for each output report having a corresponding saved output report in the collection of saved output reports,
comparing the signature for the output report to a signature for the corresponding saved output report to determine whether information in the output report differs from information in the corresponding saved output report, and
responsive to the signature for the output report being different from the signature for the corresponding saved output report, replacing the corresponding saved output report in the collection of saved output reports with the output report.

2. The method of claim 1, wherein responsive to the signature for the output report being same as the signature for the corresponding saved output report, the method further comprises:
discarding the output report.

3. The method of claim 1, wherein for each output report not having a corresponding saved output report in the collection of saved output reports, the method further comprises:
adding the output report to the collection of saved output reports.

4. The method of claim 1, wherein responsive to the signature for the output report being different from the signature for the corresponding saved output report, the method further comprises:
adding the output report to a list of updated reports to be transmitted to a server.

5. The method of claim 4, wherein an output report is transferred to the server for importation into a database only if the output report is on the list of updated reports.

6. The method of claim 1, wherein responsive to the signature for the output report being different from the signature for the corresponding saved output report, the method further comprises:
updating a signature report storing the signature for each saved output report with the signature for the output report.

7. The method of claim 1, wherein the signature of each output report is calculated using an XOR checksum algorithm.

8. A discovery system comprising:
a processor; and
a discovery manager executing on the processor, the discovery manager
conducting a discovery against a system to produce one or more output reports relating to configuration of the system,
calculating a signature for each output report based on one or more lines of data contained in each output report, the one or more lines of data not including any information with regards to timing of the discovery conducted against the system,
determining whether each output report has a corresponding saved output report in a collection of saved output reports produced from one or more previously conducted discoveries against the system, and
for each output report having a corresponding saved output report in the collection of saved output reports,
comparing the signature for the output report to a signature for the corresponding saved output report to determine whether information in the output report differs from information in the corresponding saved output report, and
responsive to the signature for the output report being different from the signature for the corresponding saved output report, replacing the corresponding saved output report in the collection of saved output reports with the output report.

9. The discovery system of claim 8, wherein responsive to the signature for the output report being same as the signature for the corresponding saved output report, the discovery manager further
discards the output report.

10. The discovery system of claim 8, wherein for each output report not having a corresponding saved output report in the collection of saved output reports, the discovery manager further
adds the output report to the collection of saved output reports.

11. The discovery system of claim 8, wherein responsive to the signature for the output report being different from the signature for the corresponding saved output report, the discovery manager further
adds the output report to a list of updated reports to be transmitted to a server.

12. The discovery system of claim 11, wherein an output report is transferred to the server for importation into a database only if the output report is on the list of updated reports.

13. The discovery system of claim 8, wherein responsive to the signature for the output report being different from the signature for the corresponding saved output report, the discovery manager further
updates a signature report storing the signature for each saved output report with the signature for the output report.

14. The discovery system of claim 8, wherein the signature of each output report is calculated using an XOR checksum algorithm.

15. A computer program product comprising a computer readable medium encoded with a computer program for managing output reports produced from discoveries conducted against systems, wherein the computer program, when executed on a computer, causes the computer to:
conduct a discovery against a system to produce one or more output reports relating to configuration of the system;
calculate a signature for each output report based on one or more lines of data contained in each output report, the one or more lines of data not including any information with regards to timing of the discovery conducted against the system;
determine whether each output report has a corresponding saved output report in a collection of saved output reports produced from one or more previously conducted discoveries against the system; and
for each output report having a corresponding saved output report in the collection of saved output reports,
compare the signature for the output report to a signature for the corresponding saved output report to determine whether information in the output report differs from information in the corresponding saved output report,
responsive to the signature for the output report being different from the signature for the corresponding saved output report, replace the corresponding saved output report in the collection of saved output reports with the output report,
responsive to the signature for the output report being same as the signature for the corresponding saved output report, discard the output report.

16. The computer program product of claim 15, wherein for each output report not having a corresponding saved output report in the collection of saved output reports, the computer program further causes the computer to:
add the output report to the collection of saved output reports.

17. The computer program product of claim 15, wherein responsive to the signature for the output report being different from the signature for the corresponding saved output report, the computer program further causes the computer to:
add the output report to a list of updated reports to be transmitted to a server.

18. The computer program product of claim 17, wherein an output report is transferred to the server for importation into a database only if the output report is on the list of updated reports.

19. The computer program product of claim 15, wherein responsive to the signature for the output report being different from the signature for the corresponding saved output report, the computer program further causes the computer to:
update a signature report storing the signature for each saved output report with the signature for the output report.

20. The computer program product of claim 15, wherein the signature of each output report is calculated using an XOR checksum algorithm.
